(19) United States
(12) Patent Application Publication
(10) Pub. No.: US 2003/0061058 A1
(43) Pub. Date: Mar. 27, 2003

(54) Method and system for evaluating a potential business transaction using electronic codification of jurisdictional regulations, rules and laws

(75) Inventors: Rabindranath Dutta, Austin, TX (US); Dwip N. Banerjee, Austin, TX (US)

Correspondence Address: Darcell Walker, 8107 Carvel Lane, Houston, TX, 77036, US

(73) Assignee: INTERNATIONAL BUSINESS MACHINES CORPORATION, ARMONK, NY

(21) Appl. No.: 09/963,713

(22) Filed: Sep. 26, 2001

(51) Int. Cl. G06F 17/60

(52) U.S. Cl. 705/1

(57) ABSTRACT

The present invention comprises a method and system that can provide information on the rules, regulations and laws that will govern a particular business transaction. The rules, regulations and laws could be for a domestic business transaction between two states or for an international transaction between nations. This invention will enable a user that desires to participate in a business transaction to access information on the particular government rules and regulations that would apply to the transaction. The user would not only receive information rules and regulations that cover the proposed transaction, but the invention would also generate a summary of the activities and costs (such as tariffs) that would occur during the proposed transaction based on the governing rules and regulations.

### FIELD OF THE INVENTION

The present invention relates to a method and system for obtaining information related to rules, regulations and laws that cover a business transaction across geographic jurisdictions. The invention, in particular, relates to a method and system that maintains automated and electronic versions of rules, regulations and laws for multiple jurisdictions that cover a potential transaction of business across at least two of the geographic jurisdictions, the rules, regulations and laws being maintained in a global communication network such that the rules, regulations and laws can be accessed and evaluated for a particular business transaction.

### BACKGROUND OF THE INVENTION

Commerce is the exchange of goods and services between parties. International trade is the exchange of goods and services between parties across national boundaries Goods can be defined as finished products, as intermediate goods used in producing other goods, or as agricultural products and foodstuffs. International trade enables a nation to specialize in those goods it can produce most cheaply and efficiently. Trade also enables a country to consume more than it would be able to produce if it depended only on its own resources. Finally, trade enlarges the potential market for the goods of a particular economy. Trade has always been the major force behind the economic relations among nations.

Because international trade is such an integral part of a nation's economy, governmental regulations are sometimes imposed in order to restrict and control this activity and to protect what are regarded as national interests. Government action may occur in response to the trade policies of other countries, or it may be resorted to in order to protect specific industries. Since the beginnings of international trade, nations have striven to achieve and maintain a favorable balance of trade—that is, to export more than they import.

The central component of international trade is the importing and exporting goods. In a money economy, goods are not merely bartered for other goods. Instead, products are bought and sold in the international market with national currencies. In an effort to improve its balance of international payments (that is, to increase reserves of its own currency and reduce the amount held by foreigners), a country may attempt to limit imports. Such a policy aims to control the amount of currency that leaves the country.

One method of limiting imports is simply to close the ports of entry into a country. More commonly, maximum allowable import quantities may be set for specific products. Such quantity restrictions are known as quotas. These may also be used to limit the amount of foreign or domestic currency that is permitted to cross national borders. Quotas are imposed as the quickest means to stop or even reverse a negative trend in a country's balance of payments. They are also used as the most effective means of protecting domestic industry from foreign competition.

Depending on the country of origin and the nature of the product, the United States may impose tariffs on imported goods. A tariff, paid by the buyer of the imported product, makes the price higher for that item in the country that imported it. The higher price reduces consumer demand and thus effectively restricts the import. The taxes collected on the imported goods also increase revenues for the nation's government. Furthermore, tariffs serve as a subsidy to domestic producers of the items taxed because the higher price that results from a tariff encourages the competing domestic industry to expand production. Some developing countries are accorded preferential treatment, resulting in the reduction or elimination of tariffs on some of the products they import into the United States. Imports from other countries (e.g., Canada and Israel) receive preferential treatment under free trade agreements. Some types of goods arrive without any tariffs at all. The United States has recently been pursuing a policy of lowering import barriers to encourage free trade. Importers should review the Harmonized Tariff Schedules of the United States regarding tariff classification, quantity restrictions and customs valuation. Licenses are only required in a few cases (e.g., for certain products, countries of origin or quantities). Goods entering the United States must be documented and cleared through the U.S. Customs Service at the port of entry.

In recent years, there has been an increase in nontariff barriers. Although a government with the intention of regulating trade does not necessarily administer these barriers, they nevertheless have that result. Such nontariff barriers include government health and safety regulations, business codes of conduct, and domestic tax policies. Direct government support of various domestic industries is also viewed as a nontariff barrier to trade, because such support puts the aided industries at an unfair advantage among trading nations.

Besides this fundamental advantage, further economic benefits result when countries trade with one another. International trade leads to more efficient and increased world production, thus allowing countries (and individuals) to consume a larger and more diverse bundle of goods. A nation possessing limited natural resources is able to produce and consume more than it otherwise could. As noted earlier, the establishment of international trade expands the number of potential markets in which a country can sell its goods. The increased international demand for goods translates into greater production and more extensive use of raw materials and labor, which in turn leads to growth in domestic employment. Competition from international trade can also force domestic firms to become more efficient through modernization and innovation.

There are no laws restricting interstate sales in the United States. A business may import your product into any state (or manufacture it there) and sell it in any other state in the United States without any customs regulations of any kind by individual states. Further, exporting your product from one of the United States to other countries often does not require any special license or permit. The exporter must, however, complete a Shipper's Export Declaration identifying the goods and their destination. A special export license may be required if the product or its destination is on the U.S. Bureau of Export Administration's control lists.

Within each economy, the importance of foreign trade varies. Some nations export only to expand their domestic market or to aid economically depressed sectors within the home economy. Other nations depend on trade for a large part of their national income and to supply goods for domestic consumption. In recent years foreign trade has also been viewed as a means to promote growth within a nation's economy. Developing countries and international organizations have increasingly emphasized such trade.

A business considering selling its product in the United States should consider the need to protect the intangible assets associated with that product. U.S. law provides for the protection of patents, trademarks, trade names and copyrights. An exporter to the United States should consider taking the necessary actions to obtain this protection, such as application for a patent or registered trademark, and ensuring that products and promotional materials bear the statutory notice provisions for trademark and copyright purposes. In addition, research should be undertaken to ensure that the intellectual property rights of others would not be infringed by the proposed sales.

In 1990 world trade (exports and imports) was approximately $6.76 trillion, roughly double the figure for 1980. Driven by inflation and higher prices for commodities such as oil, the value of world trade in U.S. dollars increased nearly tenfold between 1965 and 1985. In the 20th century, trade has increased, becoming a more dominant segment of the world's economy. It is expected that the trend toward increasing interdependency among national economies will continue into the future.

One reason for this forecasted increase in trade is the use of global computing networks in international transactions. These computer networks one commonly known as the “Internet” have made it possible for people all over the world to communicate effectively and inexpensively. These networks have also made it easier to conduct business internationally. This form of business, whether domestic or international, is known as e-commerce.

In additional, the buying and selling of products using electronic networks, including a global computer network is referred to “e-commerce”. This method of buying and selling is revolutionizing the way businesses can reach new customers while more adequately fulfilling the needs of current customers. Furthermore, the costeffectiveness of electronic commerce enables small companies to compete on a more even footing with larger organizations. At the same time, the larger companies can utilize e-commerce to instantly respond to evolving trends and to enter new markets with the agility of a smaller business.

The explosion of e-commerce has presented tremendous opportunities to create new business models on the Internet. The Internet offers immense potential for efficiency because of its transactional support structure. However, any business environment is still governed by regulations of laws and ethics and the e-commerce environment is no different. In fact, because of the potential to seamlessly bridge across national boundaries, it is even more important that rules and regulations of nations and states are followed to create an efficient, hospitable business climate. There remains a need for a method and system that can assist parties, involved in international e-commerce transaction, in the compliance with regulation and laws that would govern an international e-commerce transaction. Mechanisms may have to be put in place to even perform translations between regulation entities across boundaries in a mutually acceptable way.

### SUMMARY OF THE INVENTION

It is an objective of this invention to provide an automated method and system to support the compliance with regulations and laws during an e-commerce business transaction across state and national boundaries.

It is a second objective of this invention to provide mechanisms that perform translations of rules and regulations between countries in a mutually acceptable manner during business transactions across national boundaries.

It is a third objective of the present invention to provide mechanisms that process requests for information about business transactions across national boundaries where each country has different regulations that cover the particular business transaction.

It is a fourth objective of the present invention to provide a database that contains information about rules, regulations and laws in different countries.

It is a fifth objective of the present invention to provide a mechanism for data mining and data manipulation of laws, rules and regulations and thereby provide responses to complex queries to be posed concerning the adherence to these laws rules and regulations.

The present invention comprises a method and system that can provide information on general and specific rules, regulations and laws that will govern a particular international e-commerce business transaction. The jurisdictional rules, regulations and laws could be for a domestic business transaction between two states or for an international transaction between nations. This invention will enable a user that desires to participate in a business transaction to access information about specific government rules and regulations that would apply to the transaction. The user would not only receive information about jurisdictional rules and regulations that would cover the proposed transaction, but the invention would also generate a profile of the potential transaction that would contain a summary of the activities and costs (such as tariffs) that would occur during the proposed transaction based on the governing rules and regulations.

The system of the present invention would have as one of its cornerstone elements at least one accessible Web server dedicated to processing requests for information and generating a profile about business transactions across domains with different regulations. A second cornerstone of the system would be a (universal) database accompanying each Web server that contains information about rules, regulations and laws in participating geographical entities. In the business domain, this information may include information about the tariff structure of different countries, export-import regulations, and specific laws (e.g. US laws enforcing an embargo against Cuba, or non-trading requirement with states sponsoring terrorism). Access to these Web servers and accompanying databases would be via a global computing network such as the Internet. The actual implementation of the business transaction could also be via the Internet.

In the method of the present invention, a client (user) would enter relevant information about a particular product or product category and information describing the country that is the origin of the product and the country that is the destination of the product into a query request. The query is submitted to the Web server. The Web server receives the query, processes the information in the query and accesses the appropriate data in the accompanying database. Based on the request in the query, once the requested information has been retrieved, processes in the Web server can generate other information related to the actual activities and costs associated with the business transactions. This information is returned to the client/customer. At this point, the client has the option to reformulate the query, generate a new query concerning a new transaction or terminate the activity.

A solution to the aforesaid problem will have potential impact in both the Business-to-Consumer (B2C) and the Business-to-Business (B2B) spaces. The solution framework is very similar to the two instances although the actual implementation will be different due to the unique characteristics of the two domains.

In the B2B space, significant savings can be affected by streamlining the adherence mechanism (to business rules and regulations) in the B2B space. Thereby it makes sure rules are not broken and penalties are avoided. In the aforesaid situation, queries can be executed against the database to find out if the activity is allowed or not. Based on the results, costs can be calculated and decisions formulated. This mechanism will be especially useful for multinational companies that are active in the export-import domain. The most attractive features of the above framework in a business-to-business situation are the following:

Codification of rules & regulations of every country in the database and invoking them in specific instances to make sure illegal actions are not performed

Mechanisms for conflict resolution (may need to contact regulatory authorities in each country)

When applying translations, chose the most restrictive set of interpretations (ones that follow all the rules)

One of the major advantages of electronic codification is that changes can be reflected immediately in the knowledge base. Business clients can access the above knowledge base (database too, if required) by communicating with the server. It can be accessed through a GUI that makes it possible to easily specify business and personal situations to query the knowledge base about problems in that context.

### DESCRIPTION OF THE DRAWINGS

FIG. 1 depicts data processing equipment a system that can be utilized to implement the present invention.

FIG. 2 is a diagram of a computer network over which users can access Web servers and accompanying databases to retrieve information concerning rules, regulations and laws for business transactions across jurisdictions.

FIG. 3 is a general configuration of the system of the present invention illustrating one Web server and one accompanying database.

FIG. 4 is a general configuration of the system of the present invention illustrating multiple Web servers and multiple accompanying databases.

FIG. 5 is a flow diagram of the present invention with the client invoking the services.

FIG. 6 is a flow diagram of the present invention with the server side responding to the client request.

FIG. 7 is a detailed flow diagram of the answer generation and retrieval step of the method of the present invention.

FIG. 8 is a diagram of the storage configuration for the country, product and regulations and statutes for a particular country or jurisdiction.

FIG. 9 is an illustration of the framework for generation of uniform format for the rules, regulations and laws and for the knowledge base solutions to the submitted queries.

FIGS. 10a and 10b illustrate different formats for representing product data in different countries.

FIG. 10c illustrates a uniform format for representing product data from the formats in FIGS. 10a and 10b.

### DETAILED DESCRIPTION OF THE INVENTION

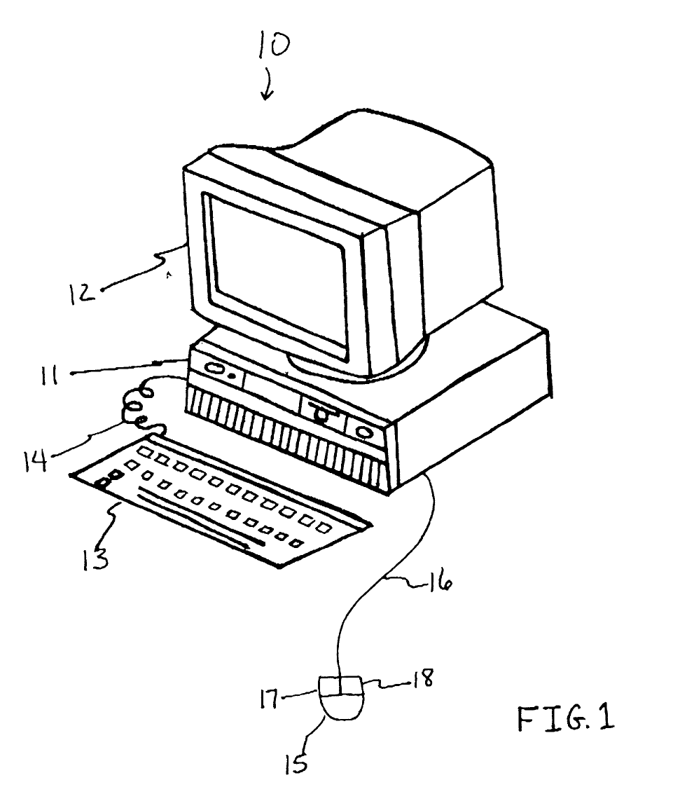

With reference now to FIG. 1, there is depicted a pictorial representation of data processing system 10 which may be used in implementation of the present invention. As may be seen, data processing system 10 includes processor 11 that preferably includes a graphics processor, memory device and central processor (not shown). Coupled to processor 11 is video display 12 which may be implemented utilizing either a color or monochromatic monitor, in a manner well known in the art. Also coupled to processor 11 is keyboard 13. Keyboard 13 preferably comprises a standard computer keyboard, which is coupled to the processor by means of cable 14. Also coupled to processor 11 is a graphical pointing device, such as mouse 15. Mouse 15 is coupled to processor 11, in a manner well known in the art, via cable 16. As is shown, mouse 15 may include left button 17, and right button 18, each of which may be depressed, or “clicked”, to provide command and control signals to data processing system 10. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those skilled in the art will appreciate that data processing system 10 may be implemented utilizing a personal computer.

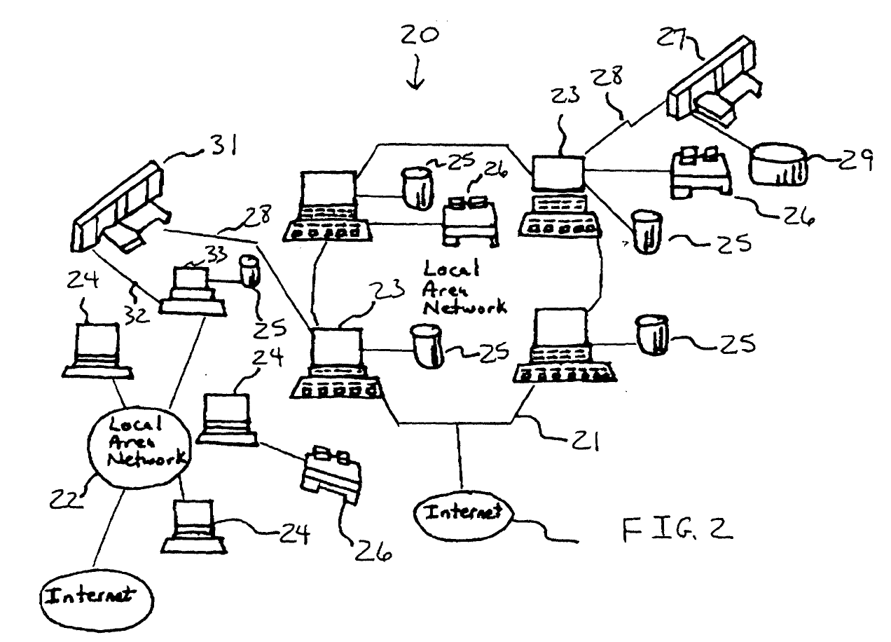

The method of the present invention may be implemented in a global computer network environment such as the Internet. With reference now FIG. 2, there is depicted a pictorial representation of a distributed computer network environment 20 in which one may implement the method and system of the present invention. As may be seen, distributed data processing system 20 may include a plurality of networks, such as Local Area Networks (LAN) 21 and 22, each of which preferably includes a plurality of individual computers 23 and 24, respectively. Of course, those skilled in the art will appreciate that a plurality of Intelligent Work Stations (IWS) coupled to a host processor may be utilized for each such network. Any of the processing systems may also be connected to the Internet as shown. As is common in such data processing systems, each individual computer may be coupled to a storage device 25 and/or a printer/output device 26. One or more such storage devices 25 may be utilized, in accordance with the method of the present invention, to store the various data objects or documents which may be periodically accessed and processed by a user within distributed data processing system 20, in accordance with the method and system of the present invention. In a manner well known in the prior art, each such data processing procedure or document may be stored within a storage device 25 which is associated with a Resource Manager or Library Service, which is responsible for maintaining and updating all resource objects associated therewith.

Still referring to FIG. 2, it may be seen that distributed data processing system 20 may also include multiple mainframe computers, such as mainframe computer 27, which may be preferably coupled to Local Area Network (LAN) 21 by means of communications link 28. Mainframe computer 27 may also be coupled to a storage device 29 which may serve as remote storage for Local Area Network (LAN) 21. A second Local Area Network (LAN) 22 may be coupled to Local Area Network (LAN) 21 via communications controller 31 and communications link 32 to a gateway server 33. Gateway server 33 is preferably an individual computer or Intelligent Work Station (IWS) that serves to link Local Area Network (LAN) 22 to Local Area Network (LAN) 21. As discussed above with respect to Local Area Network (LAN) 22 and Local Area Network (LAN) 21, a plurality of data processing procedures or documents may be stored within storage device 29 and controlled by mainframe computer 27, as Resource Manager or Library Service for the data processing procedures and documents thus stored. Of course, those skilled in the art will appreciate that mainframe computer 27 may be located a great geographical distance from Local Area Network (LAN) 21 and similarly Local Area Network (LAN) 21 may be located a substantial distance from Local Area Network (LAN) 24. That is, Local Area Network (LAN) 24 may be located in California while Local Area Network (LAN) 21 may be located within Texas and mainframe computer 27 may be located in New York.

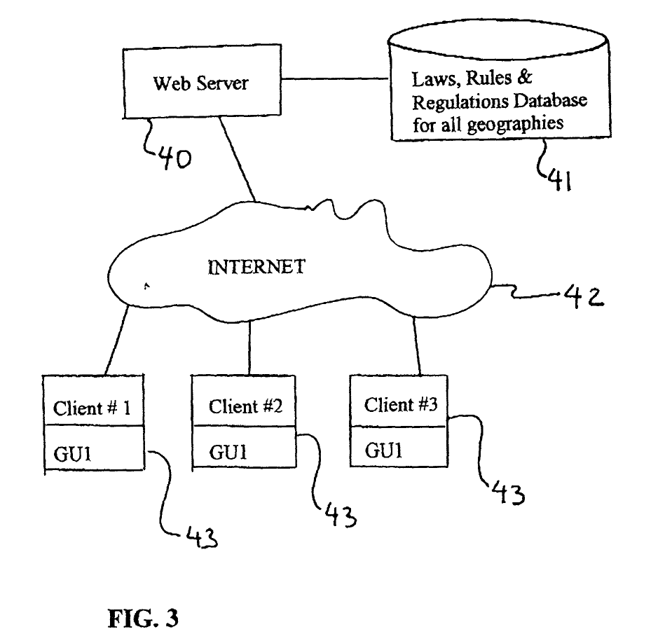

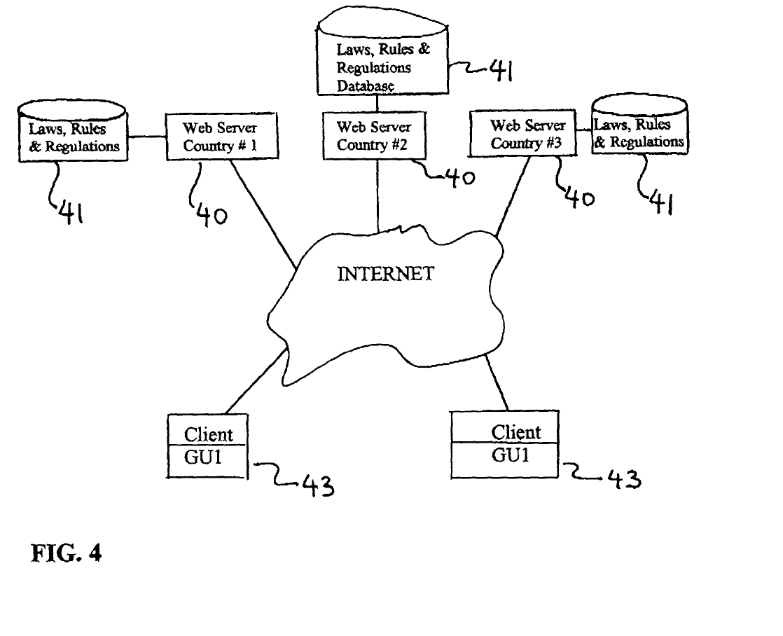

FIG. 3 is a general configuration of the system of the present invention. This configuration is a centralized computing environment in that it has one Web server 40 and one accompanying database 41. This server and database contain information about rules, regulations and laws for each jurisdiction in the system. The Web server 40 connects to the global communication network 42 and thereby enables clients 43 to access the server and database. These connections to the global communication network can be through known available means, which would include connections over a wireless network. FIG. 4 illustrates a distributed computer network environment for the present invention. As shown, this configuration has multiple Web servers 40 and accompanying databases 41. In one example, each jurisdiction in the system could have a Web server and database that would contain information for that particular jurisdiction. The clients 43 would access a particular server 40 by specifying that server during a query to the system.

As previously mentioned, a client accesses a Web server with a query for some specified information contained in the accompanying database. This information includes jurisdiction name, product name, and the tariff structure for that jurisdiction which includes duties. Other information includes import/export information. This category would contain information about which products can be imported or exported and the quantity of each product available for import or export.

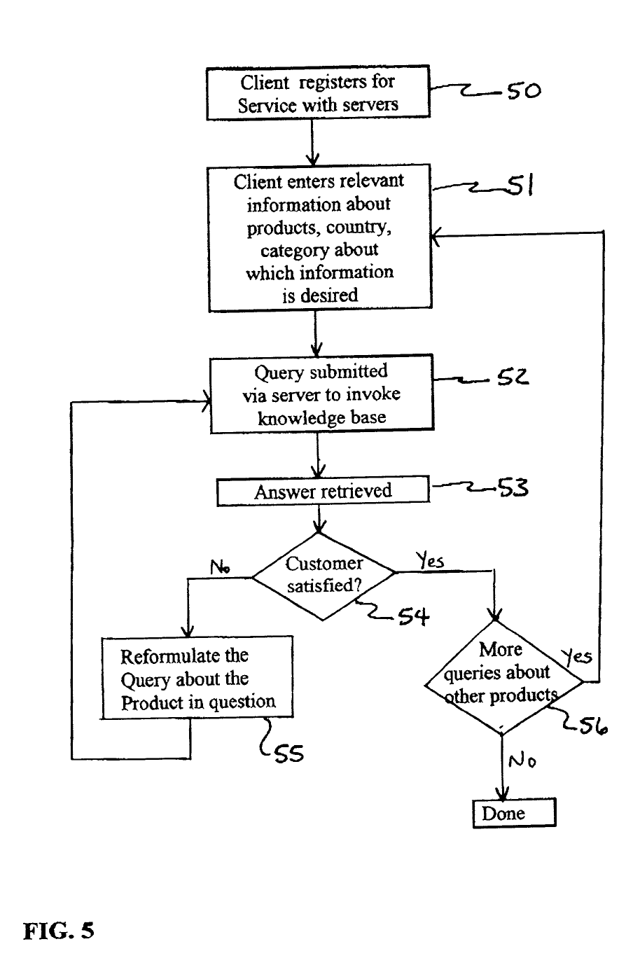

FIG. 5 illustrates the customer side operation of the method of the present invention. As shown in step 50, the customer registers for the access to a server in the system illustrated in FIGS. 3 and 4. As with many automated services, the customer will receive some access identity that will enable the system to know who is accessing the system services. This access process may be for security reasons or other purposes such as to monitor the use of the system. Once the customer has gained access to the server 40, the customer enters information that is relevant about the countries of the transaction, the particular product and the category of the transaction for which the customer desires information 51. The transaction information could be that the transaction is for the import of some particular product. Step 52 formats the customer information into a query and submits this query to the server 40 and the knowledge base. The answer to this submitted query is retrieved and submitted to the customer in step 53. At this point, there is a determination whether the customer is satisfied with the results of the query step 54. Sending an interactive inquiry to the customer could do this determination. The response could also be a “reformulate query” option that would allow the customer to modify the query. With any method, if the response from the customer is not satisfactory, then the process gives the customer the opportunity to reformulate the query about the particular transaction that is the subject of the previous query 55. The customer would then resubmit the query and the process would continue from step 52. If the response from the customer in step 54 is “Yes”, the process gives the customer the option to submit another query about another product in step 56. If the customer desires to submit another query, the process returns to step 51. If the customer does not want to submit another query, the process ends.

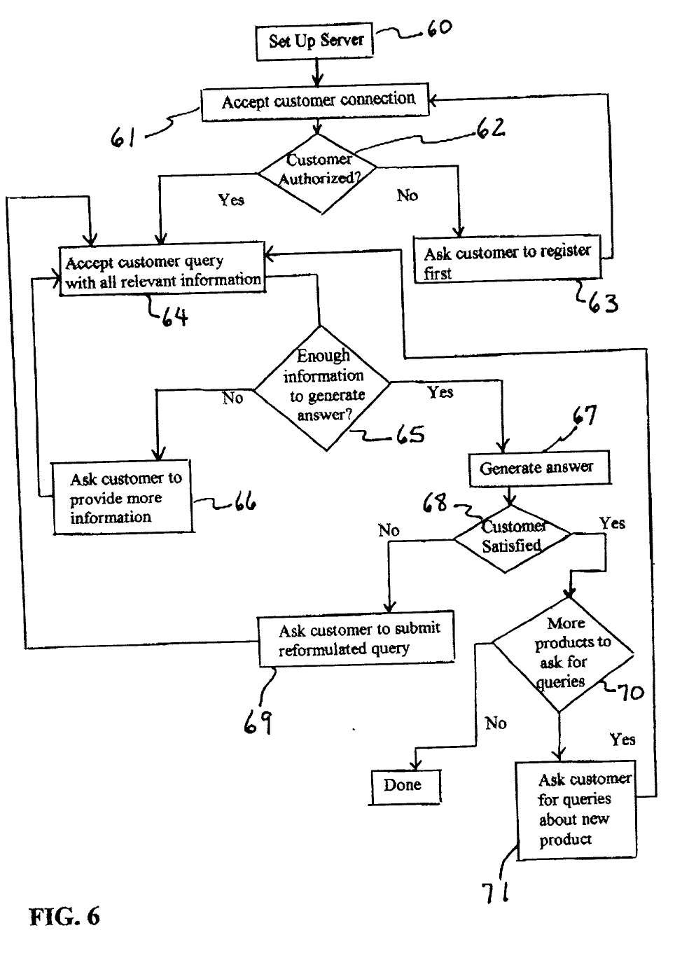

FIG. 6 illustrates the server side of the process of the present invention. The server process starts by initializing the server in step 60 to accept connections from registered clients. The processing starts when the server receives a prompt from the customer machine, which informs the server that a customer wants to connect to it for the purpose of submitting a query. The server sends a response back to the customer machine accepting the connection in step 61. In step 62, after accepting the customer connection, the server verifies that the customer is authorized to use the server of the present invention. As described in FIG. 5, step 50 required the client to register for the service with the server. If the customer is not authorized for the service, step 63 provides the opportunity for the customer to register for the service. At this point, the process returns to step 62. If in step 62, the customer is registered for the service, the process moves to step 64 and the server accepts customer query submitted in step 53.

The server processes the submitted query and begins the process of retrieving the information requested in the query. Depending on the request in the query, the process may not have sufficient information in the query to adequately respond to the query. If the determination, in step 65, is that the query does not contain sufficient information to generate a response, the server submits a request to the customer to supply additional information in step 66. This server request may identify the specific information needed to complete the response to the initial customer query. Once the server has received the additional information from the customer, the process continues at step 64.

If the query does have sufficient information, the process moves to step 67 where the server retrieves information and generates an answer to the submitted query. This query is sent back to the customer for review. If the customer is not satisfied with the results of the query in step 68, the server gives the customer the opportunity to reformulate the query about the same product, in step 69. This step 69 is the same as step 55 in FIG. 5. If in step 68, the customer determines that answer is sufficient, the process moves to step 70 where to the customer has the opportunity to submit an additional query for a new product. If the customer desires to submit another query in step 71, the server will accept a new submitted query in step 64. If the customer does not desire to submit a new query, the process terminates.

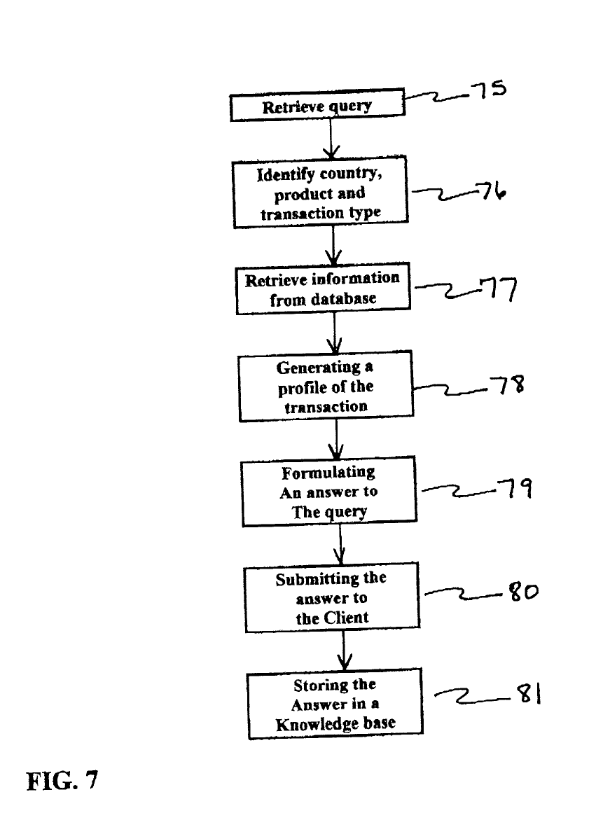

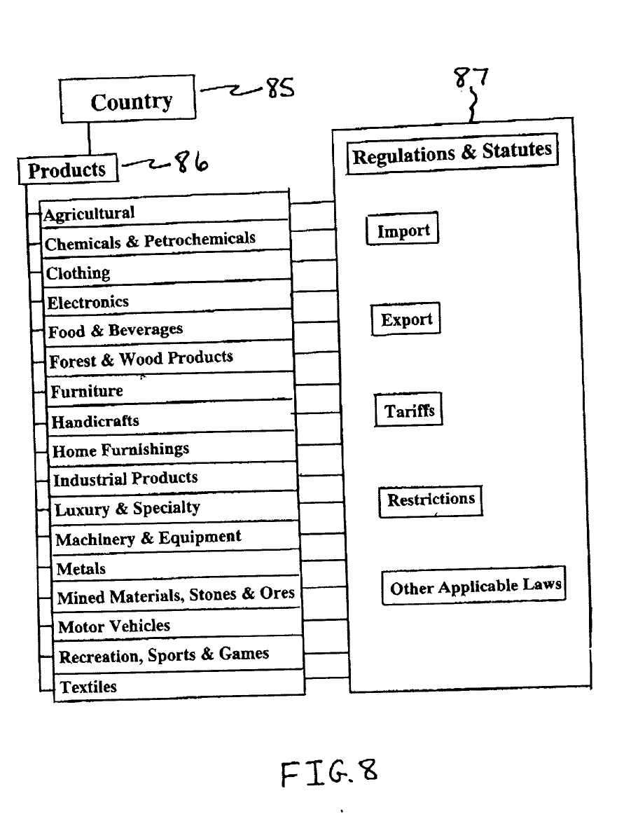

FIG. 7 gives a detailed description of the process for generating an answer to a submitted query as identified in step 55 of FIG. 5 and step 67 of FIG. 6. In step 75, the submitted query is accepted at the Web server 40. It this point, it is necessary to process the information in the query. This operation requires identifying the information contained in the query. Each query should contain certain information that is necessary in order to tell the server where in the database to retrieve information for the query. Some such information illustrated in FIG. 8 includes the identity of the country of interest, the product of interest and the transaction type. Step 76 specifically searches for this critical information in the submitted query. After the process has identified the critical information, step 77 proceeds to retrieve information in the database in order to generate an answer to the query.

The generated answer can contain only information retrieved from the database or can also include a profile of a potential business transaction involving the specified product and the designated country. Referring to FIG. 8, if the customer plans to export Product A from Country A to Country B, then the retrieved answer may include general information the export regulations from Country A that apply to Product A and the import regulations of Country B that relate to Product A. This answer could also contain general information about tariffs in Country B. Other product restrictions related to Product A and other applicable laws from both countries A and B would also be in the answer. As previously mentioned, the answer can also contain a profile of a transaction involving Countries A and B and Product A. This profile would include information on an actual transaction for the transfer of Product A from Country A to Country B. The response would have actual tariffs for the transaction and the actual quantity restrictions for exporting and importing the Product A. The response would also give information on whether there are any security related to the export or import of the product form either countries A or B. Referring to FIG. 7, step 78 generates this transaction profile as part of the operation even if the customer does not request the profile. Step 79 formulates and generates the answer to the query. After formulating the answer to the query, in step 79, the process submits the answer 80 to the customer via a global communication network. The process also stores 81 the answer to a knowledge base within the database or web server.

As shown in FIG. 8, the information in the database can be stored by country or jurisdiction. The information can be stored such that there is directory of countries. Each country 85 has links to products 86 and to regulations, statutes and other laws 87 that affect a business transaction of a product between that country and another country. The individual products have links to a specific set of regulations, statutes that would govern a transaction involving that product. During a search, the method would identify the particular product and link directly to the regulations and statutes that apply to that product. This information would be retrieved and incorporated into the answer for the submitted query. There can also be alternate configurations of the regulations and statutes section of the database. This figure shows additional information that can be incorporated in the database. In this configuration, all information for one product would be together in the same storage location instead being distributed throughout the database. This configuration would not require the use of links to data in other portions of the database.

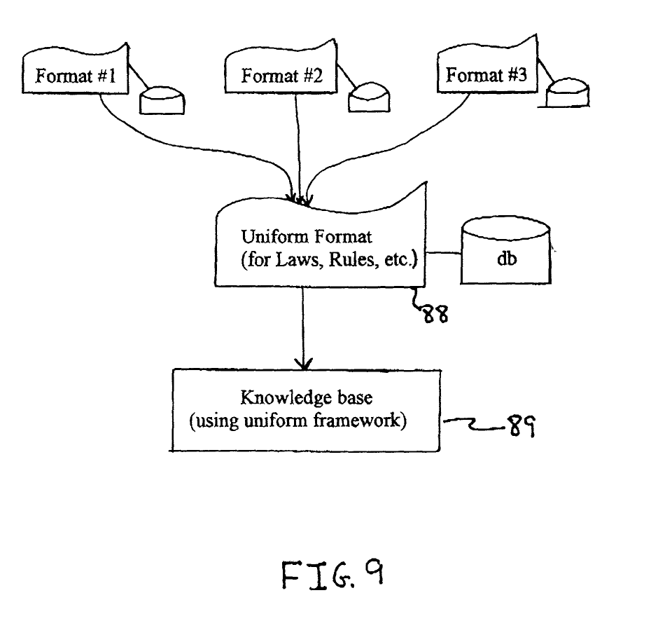

FIG. 9 is an illustration of the framework for generation of uniform format for the rules, regulations and laws and for the knowledge base solutions to the submitted queries. As shown, there is a distributed system similar to the configuration described in FIG. 4 with multiple databases. In this configuration each jurisdiction or country would have a Web server and database.

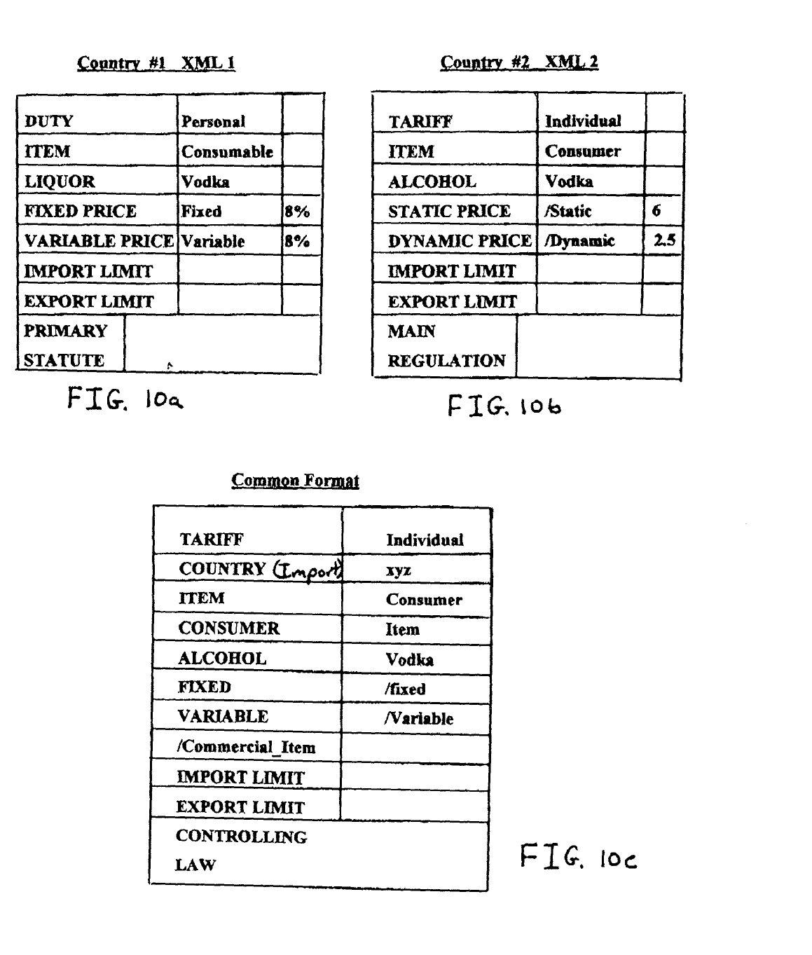

In order to communicate the laws and regulations, different countries may have different formats in which they represent a particular law or statute. Because of these different data representations, it may be necessary to create a uniform format that will enable all of the Web servers in the system to access the data in a uniform format and determine the relationship of that data to other items in the database. For example, Country A may have data in an HTML format and Country B may have the data in a text format and other countries could have a postscript format. In another example, illustrated in FIGS. 10a, 10b and 10c, there could be two countries with different XML (Extensible Mark-Up Language) formats. Country #1 may have the format for a product, alcohol, shown in FIG. 10a. Country #2 may have a different format for the same product as shown in FIG. 10b. FIG. 10c shows a common format that can represent the product information for both formats for Countries #1 and #2. A particular format may be unique to a certain country for various reasons. Referring again to FIG. 9, these different formats could all be converted using a common language to a common format at box 88 and enable any server on the system to communicate using the common format. This uniform format box would enable access to the various databases by other databases regardless of the database format.

FIG. 9 also shows the location in the database of the knowledge base 89. This data is accumulated about queries submitted over a period of time and reflects common query patterns and common information requests contained in the queries. Data mining is the practice of analyzing the data to find useful information. In this method, useful information could mean determining the tax structure of a country based on the tax regulations of that country that are stored in the regulations and statutes section of the database. As previously described in step 81, the transaction profile is sent to the knowledge base. In this knowledge base, the transactions are analyzed to develop patterns of queries. From this knowledge, there can be statistical information generated on the most frequently traded products and the countries that are most active in trading these products. This information could reveal the locations where a product is in the highest demand or which markets pay a higher price for a particular kind of product. The knowledge can also have information about what questions are asked the most in the submitted queries. This type of information could result in the development of a set of answers for the most frequently submitted queries. These types of development could result in less process time for a customer and in the ability to access more information that may assist the customer in making a decision. The ability to review the different types of transactions and get examples of theses transactions would be invaluable to a customer. This information would be available, but would also be desensitized to eliminate the disclosure of the parties to any transaction in the database. In an example, when a transaction profile is generated in step 78, the method takes the relevant laws and applies them to the facts. This process may require accessing several regulations, statutes of laws of a country. If this particular question is frequently asked, there can be formulated answer to this question that could be sent to the customer. In many cases, this simple response may satisfy a general query by a customer. According to the previous descriptions, the customer can request more information. However, in many cases the customer may be submitting a general query and may not have the information for a specific transaction.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

Having thus described the invention, what we claims as new and desire to secure by Letters Patent is set forth in the following claims.

We claim:

1. A method for maintaining, retrieving and evaluating information related to a potential business transaction between parties in different jurisdictions using electronic versions of rules from such jurisdictions that apply to the transaction comprising the steps of:
submitting a query to a database that stores the electronic versions of the rules, the query containing information about the type of transaction, the product involved in the transaction and the jurisdictions involved in the transaction;
retrieving jurisdictional rules from the database that are related the specified product, transaction type and jurisdiction;
formulating a response based on the retrieved information, said response containing general and specific jurisdictional rules that apply to the transaction and specific requirements for the transaction; and
sending the response to the entity submitting the query.

2. The method as described in claim 1 wherein said formulated response further contains a profile of the potential transaction described in the submitted query, said profile including information on product type restrictions, product tariffs and product quantity limits.

3. The method as described in claim 1 further comprising before the query submitting step, the step of registering for access to the electronic versions of rules from jurisdictions and the search and retrieved mechanisms that will respond to a submitted query.

4. The method as described in claim 1 further comprising after said response sending step, the steps of:
retrieving the formulated query response at the customer location;
evaluating the query response;
determining whether the query response is satisfactory to the customer;
reformulating the original query, when the determination is that the response is not satisfactory; and
resubmitting the reformulated query to a database that stores the electronic versions of the rules, the query containing information about the type of transaction, the product involved in the transaction and the jurisdictions involved in the transaction.

5. The method as described in claim 1 further comprising after said response sending step, the steps of:
retrieving the formulated query response at the customer location;
evaluating the query response;
determining whether the query response is satisfactory to the customer; and
when a new query is desired,
submitting a new query to a database that stores the electronic versions of the rules, the query containing information about the type of transaction, the product involved in the transaction and the jurisdictions involved in the transaction.

6. The method as described in claim 3 further comprising the step of establishing a connection between a customer and the server and associated database containing the electronic version of the rules, regulations and laws from a jurisdiction.

7. The method as described in claim 6 further comprising the step of determining whether a customer is registered to access the server and database and accepting the customer submitted query when the customer is registered to access the server and database.

8. The method as described in claim 7 further comprising the steps of:
processing the submitted query and identifying the specific request in the query;
determining whether the query contains sufficient information to enable the generation of a response of a response to the query; and
sending the request for more information to the customer, if the determination is that there is not enough information to respond to the request in the query.

9. The method as described in claim 7 further comprising the steps of:
processing the submitted query and identifying the specific request in the query;
determining whether the query contains sufficient information to enable the generation of a response of a response to the query; and
generating a response based on the retrieved information, said response containing general and specific jurisdictional rules that apply to the transaction and specific requirements for the transaction;
retrieving the formulated query response at the customer location;
evaluating the query response;
determining whether the query response is satisfactory to the customer; and
when a new query is desired,
submitting a new query to a database that stores the electronic versions of the rules, the query containing information about the type of transaction, the product involved in the transaction and the jurisdictions involved in the transaction.

10. The method as described in claim 7 further comprising the steps of:
processing the submitted query and identifying the specific request in the query;
determining whether the query contains sufficient information to enable the generation of a response of a response to the query; and
generating a response based on the retrieved information, said response containing general and specific jurisdictional rules that apply to the transaction and specific requirements for the transaction;
retrieving the formulated query response at the customer location;
evaluating the query response;
determining whether the query response is satisfactory to the customer;
reformulating the original query, when the determination is that the response is not satisfactory; and
resubmitting the reformulated query to a database that stores the electronic versions of the rules, the query containing information about the type of transaction, the product involved in the transaction and the jurisdictions involved in the transaction.

11. A method for evaluating a potential business transaction between parties in different jurisdictions using electronic versions of rules from such jurisdictions that apply to the potential transaction comprising the steps of:
retrieving a submitted query, the query containing information about the type of transaction, the product involved in the transaction and the jurisdictions involved in the transaction;
identifying transaction type, product type and jurisdiction information contained in the query;
retrieving information from a database that stores the electronic versions of the rules;
generating a profile of a potential business transaction based on the information and rules retrieved from the database that specifically apply to the potential transaction; and
sending the generated transaction profile to the entity submitting the query.

12. The method as described in claim 11 further comprising the step of storing said generated transaction profile in a knowledge base section of the database.

13. The method as described in claim 12 wherein said stored transaction profile is arranged in the database according to the jurisdiction and product type.

14. The method as described in claim 13 further comprising the step of generating a general transaction profile for a particular country and product, said general transaction profile being stored in the database and retrieved when a query contains the jurisdiction and product type listed in the profile.

15. The method as described in claim 14 said general profile generation step comprises submitting transaction data to a profile generating mechanism, said data comprises a product, a product quantity for the transaction and an export jurisdiction and an import jurisdiction.

16. The method as described in claim 15 wherein the submitted data is from transaction profiles stored in the database.

17. The method as described in claim 15 wherein the submitted data is arbitrarily generated in the database.

18. The method as described in claim 14 further comprising the step of retrieving a general transaction profile in response to a submitted transaction query comprising the steps of:
identifying the product that is involved in the transaction;
identifying the exporting and importing jurisdictions;
searching the database for a profile having the identified product, exporting jurisdiction and importing jurisdiction; and
returning a general transaction profile that matches the identified product, exporting jurisdiction and importing jurisdiction in response to the submitted query.

19. The method as described in claim 14 further comprising the step of retrieving a general transaction profile in response to a submitted transaction query comprising the steps of:
identifying the product that is involved in the transaction;
identifying the exporting and importing jurisdictions;
searching the database for a profile having the identified product, exporting jurisdiction and importing jurisdiction; and
generating a transaction profile based on the submitted query.

20. A system for maintaining, retrieving and evaluating a potential business transaction between parties in different jurisdictions using electronic versions of rules from the jurisdictions that apply to the transaction comprising:
a database that contains information about rules, regulations and laws relating to particular geographical jurisdictions;
a server in communication with said database, said server being capable of retrieving information from said database, evaluating the retrieved information and generating a response to a query based on the retrieved and evaluated information; and
a user interface capable of submitting a query from a user to said server.

21. The system as described in claim 20 further comprising multiple servers and databases.

22. The system as described in claim 20 further comprising a uniform format converter and uniform format database.

23. The system as described in claim 22 further comprising in said uniform format database, a knowledge base section.

24. The system as described in claim 20 further comprising in said database contains a list of products, which could be involved in a potential business transaction.

25. The system as described in claim 23 wherein said rules can be arranged in the database such that each product in said product list has a corresponding set of rules, regulations and laws for a particular jurisdiction.

26. A computer program product in a computer readable medium for maintaining, retrieving and evaluating information related to a potential business transaction between parties in different jurisdictions using electronic versions of rules from such jurisdictions that apply to the transaction comprising:
instructions for submitting a query to a database that stores the electronic versions of the rules, the query containing information about the type of transaction, the product involved in the transaction and the jurisdictions involved in the transaction;
instructions for retrieving rules from the database that are related the specified product, transaction type and jurisdiction;
instructions for formulating a response based on the retrieved information, said response containing general and specific rules that apply to the transaction and specific requirements for the transaction; and
instructions for sending the response to the entity submitting the query.

27. The computer program product as described in claim 26 further comprising before the query submitting instructions, instructions for registering for access to the electronic versions of rules from jurisdictions and the search and retrieval mechanisms that will respond to a submitted query.

28. The computer program product as described in claim 26 further comprising after said response sending instructions:
instructions for retrieving the formulated query response at the customer location;
instructions for evaluating the query response;
instructions for determining whether the query response is satisfactory to the customer;
instructions for reformulating the original query, when the determination is that the response is not satisfactory; and
instructions for resubmitting the reformulated query to a database that stores the electronic versions of the jurisdictional rules, the query containing information about the type of transaction, the product involved in the transaction and the jurisdictions involved in the transaction.

29. The computer program product as described in claim 26 further comprising after said response sending step, the steps of:
instructions for retrieving the formulated query response at the customer location;
instructions for evaluating the query response;
instructions for determining whether the query response is satisfactory to the customer; and
when a new query is desired, instructions for submitting a new query to a database that stores the electronic versions of the jurisdictional rules, the query containing information about the type of transaction, the product involved in the transaction and the jurisdictions involved in the transaction.

30. The computer program product as described in claim 27 further comprising instructions for establishing a connection between a customer and the server and associated database containing the electronic version of the rules, regulations and laws from a jurisdiction.

31. The computer program product as described in claim 30 further comprising instructions for determining whether a customer is registered to access the server and database and accepting the customer submitted query when the customer is registered to access the server and database.

32. The computer program product as described in claim 31 further comprising:
instructions for processing the submitted query and identifying the specific request in the query;
instructions for determining whether the query contains sufficient information to enable the generation of a response of a response to the query; and
instructions for sending the request for more information to the customer, if the determination is that there is not enough information to respond to the request in the query.

33. The computer program product as described in claim 31 further comprising:
instructions for processing the submitted query and identifying the specific request in the query;
instructions for determining whether the query contains sufficient information to enable the generation of a response of a response to the query; and
instructions for generating a response based on the retrieved information, said response containing general and specific jurisdictional rules that apply to the transaction and specific requirements for the transaction;
instructions for retrieving the formulated query response at the customer location;
instructions for evaluating the query response;
instructions for determining whether the query response is satisfactory to the customer; and
when a new query is desired, instructions for submitting a new query to a database that stores the electronic versions of the rules, the query containing information about the type of transaction, the product involved in the transaction and the jurisdictions involved in the transaction.

34. The computer program product as described in claim 32 further comprising:
instructions for processing the submitted query and identifying the specific request in the query;
instructions for determining whether the query contains sufficient information to enable the generation of a response of a response to the query; and
instructions for generating a response based on the retrieved information, said response containing general and specific jurisdictional rules that apply to the transaction and specific requirements for the transaction;
instructions for retrieving the formulated query response at the customer location;
instructions for evaluating the query response;
instructions for determining whether the query response is satisfactory to the customer;
instructions for reformulating the original query, when the determination is that the response is not satisfactory; and
instructions for resubmitting the reformulated query to a database that stores the electronic versions of the rules, the query containing information about the type of transaction, the product involved in the transaction and the jurisdictions involved in the transaction.

35. A computer program product in a computer readable medium for evaluating a potential business transaction between parties in different jurisdictions using electronic versions of rules from such jurisdictions that apply to the potential transaction comprising:
instructions for retrieving a submitted query, the query containing information about the type of transaction, the product involved in the transaction and the jurisdictions involved in the transaction;
instructions for identifying transaction type, product type and jurisdiction information contained in the query;
instructions for retrieving information from a database that stores the electronic versions of the rules;
instructions for generating a profile of a potential business transaction based on the information and rules retrieved from the database that specifically apply to the potential transaction; and
instructions for sending the generated transaction profile to the entity submitting the query.

36. The computer program product as described in claim 35 further comprising instructions for storing said generated transaction profile in a knowledge base section of the database.

37. The computer program product as described in claim 36 wherein said stored transaction profile is arranged in the database according to the jurisdiction and product type.

38. The computer program product as described in claim 37 further comprising the step of generating a general transaction profile for a particular country and product, said general transaction profile being stored in the database and retrieved when a query contains the jurisdiction and product type listed in the profile.

39. The computer program product as described in claim 38 wherein said general profile generation instruction comprises instructions for submitting transaction data to a profile generating mechanism, said data comprises a product, a product quantity for the transaction and an export jurisdiction and an import jurisdiction.

40. The computer program product as described in claim 38 further comprising the step of retrieving a general transaction profile in response to a submitted transaction query comprising:
instructions for identifying the product that is involved in the transaction;
instructions for identifying the exporting and importing jurisdictions;
instructions for searching the database for a profile having the identified product, exporting jurisdiction and importing jurisdiction; and
instructions for returning a general transaction profile that matches the identified product, exporting jurisdiction and importing jurisdiction in response to the submitted query.

41. The computer program product as described in claim 38 further comprising the step of retrieving a general transaction profile in response to a submitted transaction query comprising the steps of:
instructions for identifying the product that is involved in the transaction;
instructions for identifying the exporting and importing jurisdictions;
instructions for searching the database for a profile having the identified product, exporting jurisdiction and importing jurisdiction; and
instructions for generating a transaction profile based on the submitted query.

42. The system as described in claim 20 wherein the connection and communication between the elements in said system can be wireless communication.

43. The method as described in claim 1 wherein said database query is submitted to the database over a wireless connection.
